(19) United States
(12) Patent Application Publication
(10) Pub. No.: US 2026/0356000 A1
(43) Pub. Date: Nov. 12, 2026

(54) DIRECT DRIVE PLANER

(71) Applicant: MILWAUKEE ELECTRIC TOOL CORPORATION, Brookfield, WI (US)

(72) Inventors: Caleb M. Schober, Milwaukee, WI (US); Christopher M. Didier, Milwaukee, WI (US)

(21) Appl. No.: 19/670,546

(22) Filed: May 7, 2026

Related U.S. Application Data
(60) Provisional application No. 63/802,000, filed on May 8, 2025.

(51) Int. Cl. B27C 1/10; B27C 1/14

(52) U.S. Cl. CPC B27C 1/10; B27C 1/14

(57) ABSTRACT

A handheld workpiece finishing tool includes a housing including a handle and a battery receptacle for selectively receiving a battery and an electric motor supported by the housing. The electric motor includes a stator coupled to a stationary shaft and a rotor rotatable relative to the stator. The handheld workpiece finishing tool further includes a drum coupled to the housing and rotatably driven by the electric motor. The drum weighs less than 220 grams and includes an outer radial profile having a diameter greater than 55 millimeters. The drum is coupled for co-rotation with the rotor about a rotational axis defined by the stationary shaft.

### CROSS-REFERENCE TO RELATED APPLICATIONS

This application claims priority to U.S. Provisional Patent Application No. 63/802,000, filed May 08, 2025, the entire content of which is incorporated herein by reference.

### FIELD OF THE DISCLOSURE

The present disclosure relates to handheld electric planers, and more particularly, to battery-powered direct drive handheld electric planers.

### BACKGROUND OF THE DISCLOSURE

Handheld electric planers adjust the thickness of a board by removing a uniform layer of material determined by a cutting depth altered by an adjustable front shoe. To remove the material, the electric planers include cutting blades typically mounted to a rotatable drum that is rotationally driven by an electric motor. In conventional handheld electric planers, the electric motor rotatably drives the drum via a belt-drive system utilizing a v-belt, or the like. To protect the user from interfering with the rotating belt, handheld planers usually include a belt guard. However, belt-driven electric planers tend to be larger and bulkier tools overall as compared to a non-belt-driven alternative, due to the added space required for the belt-drive and the need to incorporate a belt guard.

### SUMMARY OF THE DISCLOSURE

One aspect of the present disclosure relates to a handheld workpiece finishing tool including a housing including a handle and a battery receptacle for selectively receiving a battery; an electric motor supported by the housing, the electric motor including a stator coupled to a stationary shaft, and a rotor rotatable relative to the stator; and a drum coupled to the housing and rotatably driven by the electric motor, the drum weighing less than 220 grams and including an outer radial profile having a diameter greater than 55 millimeters, wherein the drum is coupled for co-rotation with the rotor about a rotational axis defined by the stationary shaft.

Another aspect of the present disclosure relates to a handheld planing tool including a main housing including a shoe, a handle, and a battery receptacle for selectively receiving a battery, the main housing defining a height between the shoe and the handle; an electric motor supported by the main housing, the electric motor including a stator coupled to a stationary shaft, and a rotor positioned radially outward of the stator; and a cutting head coupled to the main housing and rotatably driven by the electric motor, the cutting head including a channel defined by opposing sidewalls formed on an outer radial surface of the cutting head, and a blade retention mechanism located within the channel for retaining a cutting blade, wherein the cutting head has a diameter greater than 55 millimeters, and wherein the height is less than 140 millimeters.

Still another aspect of the present disclosure relates to a handheld planing tool including a housing including a handle and a battery receptacle for selectively receiving a battery; an electric motor supported by the housing; and a cutting head coupled to the housing and rotatably driven by the electric motor, the cutting head including a channel defined by opposing sidewalls formed on an outer radial surface of the cutting head, and a blade retention mechanism located within the channel for retaining a cutting blade, the blade retention mechanism having a blade holder for clamping the cutting blade between one of the opposing sidewalls and the blade holder.

Other features and aspects of the disclosure will become apparent by consideration of the following detailed description and accompanying drawings.

### BRIEF DESCRIPTION OF THE DRAWINGS

FIG. 1 is a side view of a planer in accordance with an embodiment of the present disclosure.

FIG. 2 is a perspective view of an embodiment of a cutting head for use with the planer of FIG. 1.

FIG. 3 is a cross-sectional view of the cutting head of FIG. 2, taken along section line 3—3.

FIG. 4 is a perspective view of a rotor for use with a motor in the cutting head of FIG. 2.

FIG. 5 is a cross-sectional view of the cutting head of FIG. 2, taken along section line 5—5.

FIG. 6 is a perspective view of another embodiment of a cutting head for use with the planer of FIG. 1.

FIG. 7 is an enlarged view of the cutting head of FIG. 6 illustrating an embodiment of a blade retention mechanism.

FIG. 8 is a perspective view of another embodiment of a cutting head for use with the planer of FIG. 1.

FIG. 9 is a side view of a conventional handheld planer, illustrating a height dimension.

FIG. 10 is a front view of the conventional handheld planer of FIG. 9, illustrating a width dimension.

FIG. 11 is a front view of the handheld planer of FIG. 1, illustrating a comparative width dimension.

FIG. 12 is a side view of a planer in accordance with another embodiment of the present disclosure.

FIG. 13 is a front view of the planer of FIG. 12.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

The following description includes examples of the disclosed technology. Numerous details and examples are included for the purpose of providing a thorough understanding of the disclosed subject matter and its relevant teachings. Those skilled in the relevant art, however, may understand how to apply the relevant teachings without such details. Aspects of the disclosed subject matter are not limited to the specific devices, systems, and methods described because the relevant teachings can be applied or practiced in a variety of ways. The terminology and nomenclature used herein is for the purpose of describing particular aspects only and is not intended to be limiting. In general, well-known structures or techniques are not necessarily shown in detail.

The disclosed technology will be described more fully hereinafter with reference to the accompanying drawings. This disclosed technology can, however, be embodied in many different forms and should not be construed as limited to the examples set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

In the following description, numerous specific details are set forth. But it is to be understood that examples of the disclosed technology can be practiced without these specific details. In other instances, well-known methods, structures, and techniques have not been shown in detail in order not to obscure an understanding of this description. References to “one embodiment,” “an embodiment,” “example embodiment,” “some embodiments,” “certain embodiments,” “various embodiments,” etc., indicate that the embodiment(s) of the disclosed technology so described may include a particular feature, structure, or characteristic, but not every embodiment necessarily includes the particular feature, structure, or characteristic. Further, repeated use of the phrase “in one embodiment” does not necessarily refer to the same embodiment, although it may.

To the extent any aspects of the disclosed technology are presented in a range of formats (e.g., a range of values), it is to be understood that such descriptions are merely for convenience and brevity and should not be construed as an inflexible limitation on the scope of the disclosed technology. Accordingly, the description of a range should be considered to have specifically disclosed all the possible subranges as well as individual rational numerical values within that range. For example, a range described as being “from 1 to 6” or “from approximately 1 to approximately 6” includes the values 1, 6, and all values therebetween. Likewise, a range described as being “between 1 and 6” or “between approximately 1 and approximately 6” includes the values 1, 6, and all values therebetween. The same premise applies to any other language describing a range of values. That is to say, any ranges disclosed herein are inclusive of the respective endpoints, unless otherwise indicated.

Herein, the use of terms such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential.

The terms “approximately” and “about,” as used herein, refer to slight variations of the specified values. These variations may occur due to manufacturing tolerances, measurement limitations, or inherent variability in conditions, and should be understood to allow for a reasonable margin of error that would not materially affect the disclosed technology or its operation. Unless otherwise indicated, such terms generally encompass a range of ±10 % of the referenced value.

Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

Unless otherwise specified, the use of the ordinal adjectives “first,” “second,” “third,” etc., to describe a common object, merely indicate that different instances of like objects are being referred to, and are not intended to imply that the objects so described should be in a given sequence, either temporally, spatially, in ranking, or in any other manner.

Additional objects, advantages, and novel features of the examples will be set forth in part in the following description, and in part will become apparent to those skilled in the art upon examination of the following and the accompanying drawings or may be learned by production or operation of the examples. The objects and advantages of the present subject matter may be realized and attained by means of the methodologies, instrumentalities, and combinations particularly pointed out in the appended claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

For the purpose of promoting an understanding of the principles of the present disclosure, reference will now be made to the illustrative examples provided in the drawings, and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

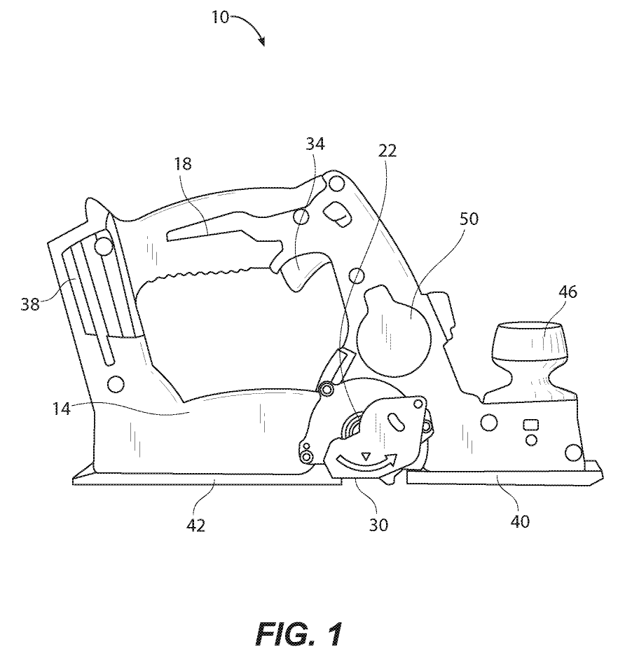

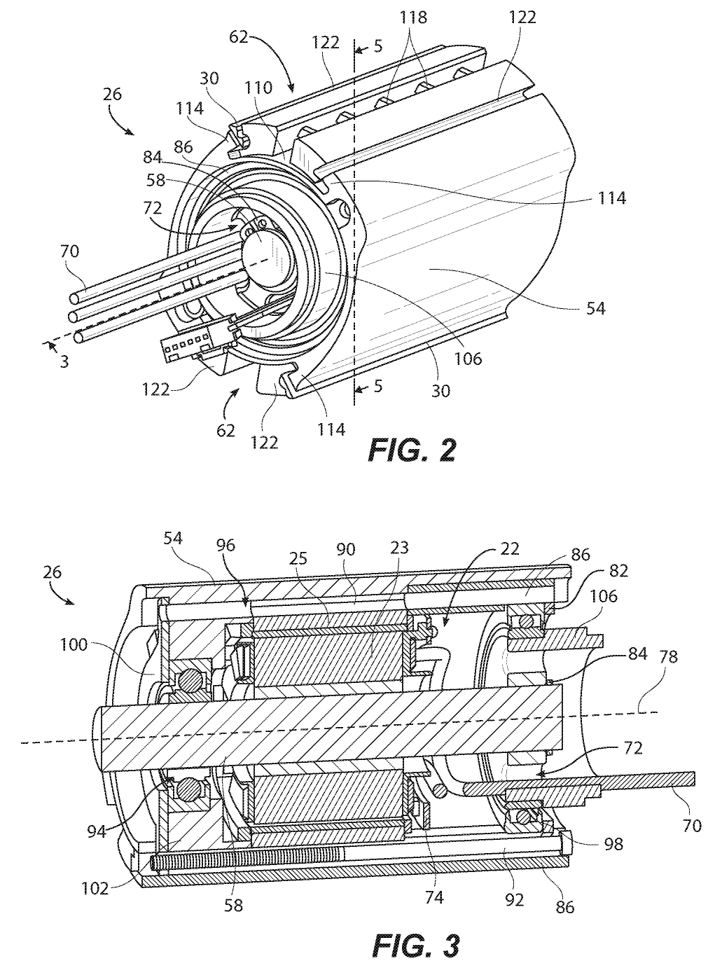

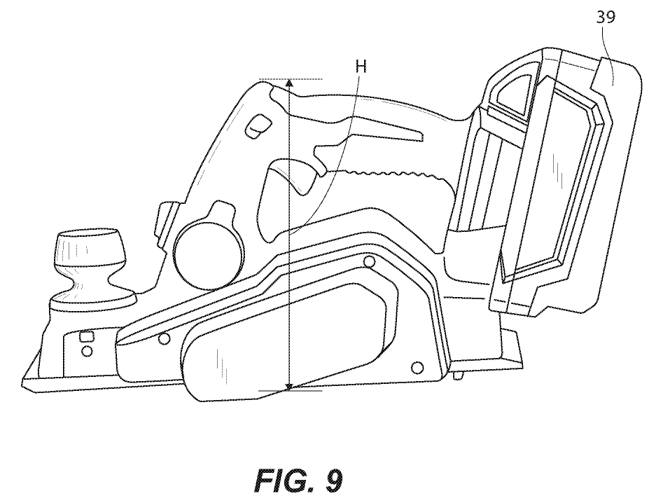

FIG. 1 illustrates a handheld workpiece finishing tool, such as an electric planer 10 or “planer,” in accordance with an embodiment of the present disclosure. In other embodiments, the handheld workpiece finishing tool could be a sander (e.g., a rotary drum sander), a rotary tool, or another drum-tool. The planer 10 includes a main housing 14 having a handle 18 extending upwardly from the main housing 14 that is graspable by a user during use, an electric motor 22 supported within the main housing 14 for rotatably driving a drum, such as a cutting head 26 (FIG. 2) with a plurality of cutting blades 30. The planer 10 further includes a controller (not shown) supported within the main housing 14, and a trigger 34 protruding from the handle 18 that is electrically connected to the controller for providing an input signal to the controller to activate and deactivate the motor 22 in response to actuation of the trigger 34, and a battery receptacle 38 for selectively electrically receiving a battery pack 39 (FIG. 9) configured to electrically power the motor 22. In some embodiments, the battery receptacle 38 is located at an end of the handle 18.

The battery pack 39 may be one or more power tool battery packs generally used to power a power tool, such as a planer, an electric drill, a light, a vacuum, a radio, an electric saw, and the like (e.g., an 18-volt rechargeable battery pack, or an M18 REDLITHIUM battery pack sold by Milwaukee Electric Tool Corporation). The battery pack 39 may include lithium-ion (Li-ion) cells. In other embodiments, the battery packs may be of a different chemistry (e.g., nickel-cadmium (NiCa or NiCad), nickel-hydride, and the like). The battery pack 39 may be a 12-volt battery pack, an 18-volt battery pack, a 4-volt battery pack, a 28-volt battery pack, a 40-volt battery pack, or a battery pack of any other voltage such that the capacity of the battery pack may vary. The battery pack 39 may further include an indicator to display the current state of charge of the battery pack 39 and/or other characteristics of the battery pack 39.

With continued reference to FIG. 1, the main housing 14 is supported on a work surface by both a front shoe 40 and a rear shoe 42. The rear shoe 42 remains stationary with respect to the work surface (e.g., a wood board), while a height of the front shoe 40 is adjustable relative to the work surface by an adjustment knob 46 located on the main housing 14. The height of the front shoe 40 relative to the work surface corresponds to a cutting depth of the cutting blades 30 in the work surface. Additionally, to facilitate debris removal from the cutting blades 30, the planer 10 may include a dust extraction port 50 extending through part of the handle 18 for expelling wood chips or other debris. In some embodiments, the dust extraction port 50 is located elsewhere on the main housing 14, such as adjacent to the adjustment knob 46.

The planer 10 may further include a guard assembly 51 positioned adjacent the motor 22 and/or the cutting blades 30 to at least partially cover sides of the motor 22. This arrangement may, in some instances, protect a user from unwanted contact with the motor 22, protect the motor 22 from damage, etc. In some instances, the guard assembly 51 includes a rigid base 52 and an adjustable cover 53. The rigid base 52 may be secured to the main housing 14, while the adjustable cover 53 may be movably supported by the rigid base 52. In some example arrangements, the adjustable cover 53 is supported directly on the main housing 14 and/or another part of the planer 10. In still some example arrangements, the adjustable cover 53 is omitted, and the rigid base 52 covers the motor 22.

Depending on a desired type of cut (e.g., planer cut, single edge cut, rabbet cut, etc.), a user may adjust the guard assembly to expose one or both sides of the cutting blades 30. In one instance, for example, a user may adjust the adjustable cover 53 to expose one side of the cutting blades 30 in order to achieve a rabbet cut on an end or face of the workpiece. Because the guard assembly 51 may be provided on both sides, a user may adjust the adjustable cover 53 based on the orientation required for the cut. In some embodiments, the adjustable cover 53 may be spring-actuated and/or biased into a downward position, in shown in FIG. 1, in which side of the blades 30 are substantially not exposed.

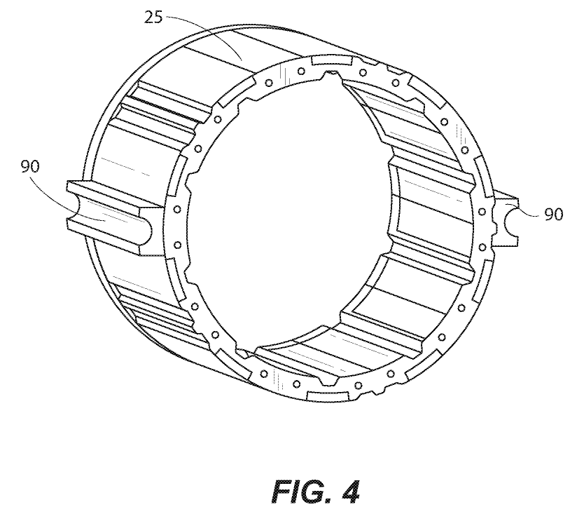

FIGS. 2-5 illustrate an embodiment of the cutting head 26 for use with the planer 10. In the illustrated embodiment, the cutting head 26 and the motor 22 are integrated as one part. The cutting head 26 includes a main body 54, the motor 22 supported within the main body 54, a fixed shaft 58 extending through the main body 54 to support the cutting head 26 within the main housing 14, and a plurality of blade retention mechanisms 62 for retaining the cutting blades 30, which is described in more detail below. The motor 22 includes a stator 23 (FIG. 3) that is coupled to the stationary shaft 58, a rotor 25 configured to rotate externally around the stationary stator 23, control electronics (e.g., printed circuit board, circuitry, etc.), and conductors 70 (e.g., control wiring, power wiring, etc.) configured to electrically communicate with electrical components (e.g., a hall-effect sensor 74, the controller, the battery pack 39, and/or the like) within the planer 10.

In the illustrated embodiment, the hall-effect sensor 74 is positioned adjacent the motor 22. In some instances, the hall-effect sensor 74 is supported by the main body 54, the stator 23, and/or another part of the planer 10. The controller, which may be similarly supported within the motor 22 and/or main housing 14, is used for controlling the rotational speed of the motor 22 based on actuation of the trigger 34, with electrical communication being provided by the conductors 70.

With continued reference to FIGS. 2-5, the rotor 25 is configured to co-rotate with the cutting head 26 about a rotational axis 78 defined by the stationary shaft 58. To rotationally affix the rotor 25 to the main body 54 of the cutting head 26, the cutting head 26 includes a retainment ring 82 having a plurality of bosses 86 coupled to the retainment ring 82 for aligning with respective mounting features 90 located on an outer periphery of the rotor 25. In some instances, the retainment ring 82 is positioned adjacent the motor 22. The cutting head 26 may further include a retaining ring 84 coupled to the stationary shaft 58. In some examples, the retaining ring 84 is and/or includes a snap ring, a push on ring, split ring, a lock nut ring, an e-clip ring, and/or the like.

A fastener 92 is configured to extend through the bosses 86 and into the mounting features 90 to couple the rotor 25 and the main body 54 of the cutting head 26. Further, the mounting features 90 are complementary to ports 96 formed in the main body 54, which may terminate at a cap 100 (e.g., end cap, retainer shield, etc.). In some instances, the fastener 92 may be inserted through the boss 86 in the retaining ring 82, extend through the mounting features 90 extending from the rotor 25, into the ports 96, and through the cap 100. In such instances, an end of the fastener 92 may be secured against the cap 100 by a stopper (not shown), such as a threaded nut, winged nut, weld, or the like. In the illustrated embodiment, the mounting features 90 may be substantially U-shaped. In some instances, the mounting features 90 may be and/or include through holes, slots, discrete recesses, or the like.

In some embodiments, the fastener 92 may be a screw, a bolt, a rod, or the like that generally couples together the main body 54 and the rotor 25. In other embodiments, the rotor 25 is press-fit into the main body 54 of the cutting head 26. Such mounting arrangement allows for better translation of torque between the rotor 25 and the main body 54, namely for moving the cutting blades 30. Additionally, this mounting arrangement inhibits slippage between the rotor 25 and the main body 54 if the cutting blades 30 strike a nail or other foreign object in the work surface. Stated differently, the rotor 25 may be rigidly connected to the main body 54.

Referring now to FIGS. 3-5, the cutting head 26 further includes a first bearing 94 and a second bearing 98 for rotatably supporting the main body 54 of the cutting head 26. The first bearing 94 is supported on one end of the stationary shaft 58 and retained by the main body 54 of the cutting head 26 via a support rib 102 extending radially inward from the main body 54. In some embodiments, the first bearing 94 can be supported on the stationary shaft 58 within the rotor 25. The first bearing 94 is further constrained axially (e.g., along the rotational axis 78) by the cap 100 and at least a portion of the support rib 102.

The second bearing 98 is supported on a flange 106, which supports the other end of the stationary shaft 58 opposite the first bearing 94. In some arrangements, the flange 106 and the stationary shaft 58 are integrally formed as a single piece, body, component, member, or the like. In the illustrated arrangement, the retaining ring 84 is coupled to the stationary shaft 58 to axially constrain the flange 106 relative to the stationary shaft 58. In some embodiments, the one end of the stationary shaft 58 supported by the first bearing 94 is also supported by a flange. In such instances, a flange may be radially positioned between the stationary shaft 58 and the first bearing 94. In the illustrated embodiment, the second bearing 98 is further supported axially and radially by the retainment ring 82 fastened to the main body 54.

As such, the rotor 25, the main body 54, the retainment ring 82, the fastener 92, the first bearing 94, the second bearing 98, and the cap 100 collectively rotate relative to the stationary shaft 58 during a planing operation (e.g., when the trigger 34 is actuated). In other embodiments, the cutting head 26 includes more than two bearings. In some instances, the motor 22 can be cantilevered on the stationary shaft 58 off to one side of the main housing 14. In such instances, one of the first bearing 94 and the second bearing 98 may be omitted, such that the cutting head 26 may be cantilevered (e.g., having a supported end and a free end) off a single bearing. By reducing the number of bearings, the motor 22 may be more completely and/or easily sealed. A reduced number of bearings may also simplify assembly of the motor 22 and/or cutting head 26.

In some embodiments, the conductors 70 may be routed from the main housing 14 into the cutting head 26 through the flange 106. In such embodiments, the flange 106 may include a passage 72 (e.g., a bore, slot, channel, or conduit) formed in the flange 106 and sized to receive one or several of the conductors 70 and/or the control electronics. In some embodiments, the passage 72 is configured to provide strain relief to the conductors 70, such as by including a radiused entry, a grommet, a clamp feature, and/or a potted region. In some embodiments, the passage 72 is sealed (e.g., with an elastomeric seal, grommet, or potting compound) to reduce ingress of debris (e.g., wood dust) into the cutting head 26 and/or to protect the conductors from abrasion. Further, as best illustrated in FIG. 2, the passage 72 may include a plurality of openings positioned, for example, around the stationary shaft 58.

In some embodiments, the planer 10 is configured to mitigate kick-back, loss of control, and/or other undesirable events during the planing operation. For example, the controller can be configured to detect one or more operating conditions indicative of a kick-back event, a stall condition, a rapid deceleration of the cutting head 26, an over-current condition, and/or a loss-of-control condition. In response to detection, the controller can be configured to perform an auto-stop operation (e.g., automatically stop) including one or more of: reducing a duty cycle to the motor 22, interrupting power to the motor 22, applying an electronic braking operation to the motor 22, and/or inhibiting a restart until a user input is received (e.g., releasing and re-actuating the trigger 34). In some embodiments, the controller detects the operating condition based on one or more sensed parameters such as motor current, motor voltage, back-EMF, rotor position signals (e.g., via the hall-effect sensor 74), speed and/or acceleration of the cutting head 26, and/or a signal from an inertial sensor (e.g., accelerometer or gyroscope) supported by the main housing 14.

In some embodiments, the adjustment knob 46 is associated with a depth sensing system configured to detect a cutting depth setting and/or a position of the front shoe 40 relative to the main housing 14. In some instances, the depth sensing system includes an inductive sensor (e.g., an eddy-current sensor) configured to detect a position of a conductive target coupled to the adjustment knob 46, a linkage associated with the front shoe 40, and/or the front shoe 40 itself. The controller can be configured to use the depth sensing system to provide improved accuracy and/or repeatability of the depth setting (e.g., via a displayed depth value and/or by controlling operation of the motor 22 based on a detected depth setting).

Additionally or alternatively, in some embodiments, the planer 10 includes a two-handed operation feature configured to reduce inadvertent activation and/or improve user safety. For example, the controller can be configured to inhibit motor operation unless both (i) the trigger 34 is actuated and (ii) a second input is detected (e.g., actuation of a second switch, detection of a user gripping a forward handle region, or detection of a user interaction with the adjustment knob 46). In some embodiments, such second input is provided by a non-contact sensor (e.g., an inductive sensor) and/or a contact sensor supported by the housing. In some instances, the knob 46 may be locked (e.g., rotationally constrained) and unlocked (e.g., rotatable) to allow a user to freely rotate the knob 46 during use, thereby increasing usability of the planer 10.

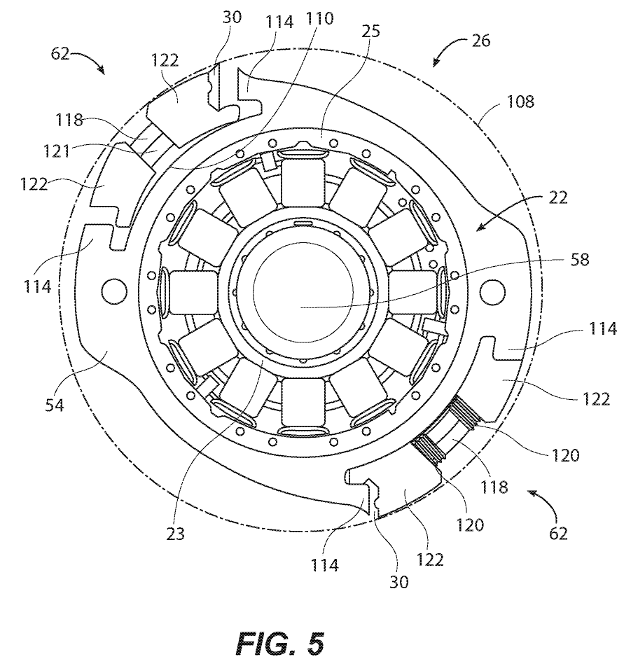

With reference to FIGS. 2 and 5, the blades 30 are retained on an outer radial profile 108 of the cutting head 26 by the blade retention mechanism 62. In the illustrated embodiment, the blade retention mechanism 62 is located within a channel 110 adjacent the outer radial profile 108 of the cutting head 26 that is defined by opposing sidewalls 114. In some instances, the channel 110 is at least partially curved. In other instances, the channel 110, or a plurality of the channels 110, extends around between approximately 20 % and approximately 50 % (e.g., approximately 35 %) of the outer radial profile 108. In other instances, the channel 110 may be generally flat (e.g., not curved). Additionally, in the illustrated embodiment, the cutting head 26 includes two channels 110 positioned generally opposite one another. In other embodiments, the cutting head 26 includes greater than two channels 110 (e.g., three, four, five, or more) or fewer than two channels 110.

Referring still to FIGS. 2 and 5, the blade retention mechanism 62 includes a plurality of threaded rods 118 having jaws 122 coupled on either side of the threaded rods 118. Each of the jaws 122 extends along a length of the channel 110 and are configured to selectively abut one of the sidewalls 114 of the channel 110 to clamp one of the blades 30 between the jaws 122 and the sidewalls 114. In the illustrated embodiment, the threaded rods 118 include one or more flat surfaces 121. In some instances, the threaded rods 118 include five flat surfaces 121 (e.g., to form a hexagonal cross-section). In other instances, the threaded rods 118 include greater than five flat surfaces 121 (e.g., to form a cross-section that is hexagonal, octagonal, or the like) or fewer than five flat surfaces 121 (e.g., to form a cross-section that is polygonal). In further instances, the threaded rods 118 include flat surfaces 121 and curved surfaces to form a cross-section that is at least partially polygonal and at least partially non-polygonal or substantially ovular.

To retain the cutting blades 30, each of the threaded rods 118 may be rotated using a tool (e.g., a wrench), or a user’s hands, which rotates external threads 120 (FIG. 5) on each of the threaded rods 118 that mate with internal threads within each of the jaws 122. More specifically, such a tool may be placed in register with the flat surfaces 121, thereby allowing a torque force to be applied to the threaded rods 118. When the threaded rods 118 are rotated, the threaded connection between the rods 118 and jaws 122 causes each of the jaws 122 to move circumferentially outward until the blades 30 are clamped between the jaws 122 and the sidewalls 114 of the channel 110. To replace one of the blades 30, the threaded rods 118 can be rotated in an opposite direction to loosen the tension between the sidewalls 114 and move the jaws 122 circumferentially inward toward each other. In some embodiments, the blade retention mechanism 62 is a turnbuckle-style mechanism.

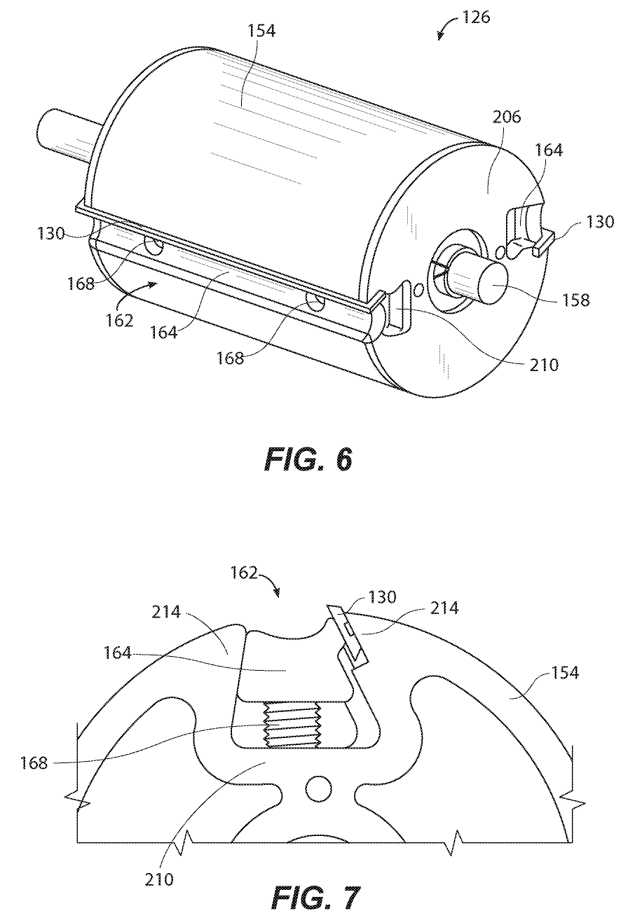

FIGS. 6 and 7 illustrate another embodiment of a cutting head 126 for use with the planer 10 with like components and features of the cutting head 26 plus “100.” The cutting head 126 includes a main body 154 and a motor (not shown) mounted to a stationary shaft 158 extending through the main body 154. The motor includes a stator mounted to the stationary shaft 158 and a rotor configured to rotate about the stationary stator to co-rotate with the main body 154. The cutting head 126 further includes channels 210 formed within the main body 154 that are each defined by opposing sidewalls 214, and a blade retention mechanism 162 located in the channels 210 for retaining one or more cutting blades 130.

The blade retention mechanism 162 includes a blade holder 164 that extends along the length of the channel 210, and a plurality of fasteners 168 for anchoring the blade holder 164 within the channel 210. Each of the cutting blades 130 is clamped between one of the sidewalls 214 and the blade holder 164. In the illustrated embodiment, to clamp the blades 130 in place, the fasteners 168 are threaded into the channel 210 and through the blade holder 164 until the blade 130 is firmly clamped between one of the sidewalls 214 and the blade holder 164. Blades 130 can be replaced by simply unthreading the fasteners 168.

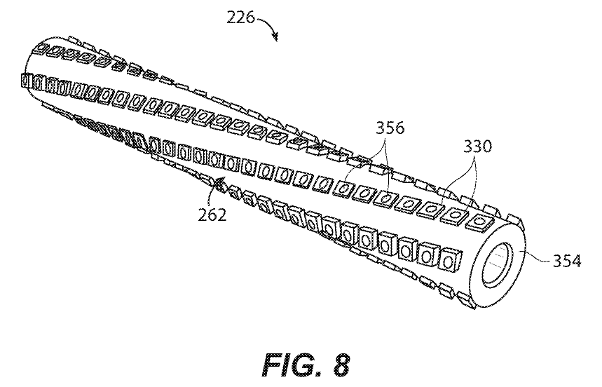

FIG. 8 illustrates another embodiment of a cutting head 226 for use with the planer 10 with like components and features of the cutting head 26 plus “200.” The cutting head 226 includes a main body 354 having a plurality of cutting blades 330 helically disposed about the outer radial surface of the cutting head 226. The cutting head 226 also includes a blade retention mechanism 262 for retaining the cutting blades 330 on the cutting head 226. The blade retention mechanism 262 includes a fastener 356 (e.g., a screw) for fastening each individual cutting blade 330 in the helical pattern on the outer radial surface of the cutting head 226.

With reference now to FIGS. 2-8, in some embodiments, the motor 20 includes a width of between approximately 40 millimeters (mm) and approximately 60 mm (e.g., approximately 50 mm, approximately 55 mm, etc.). In one embodiment, the motor 20 includes a width of approximately 52.2 mm. In another embodiment, the motor 20 includes a width of approximately 43 mm. In other embodiments, the motor 20 includes a width of approximately 42.9 mm.

In some embodiments, the motor 20 includes a diameter of between approximately 40 mm and approximately 55 mm (e.g., approximately 45 mm, approximately 50 mm, etc.). In one embodiment, the motor 20 includes a diameter of approximately 47.4 mm. In another embodiment, the motor 20 includes a diameter of approximately 43 mm. In other embodiments, the motor 20 includes a diameter of approximately 42.9 mm.

In some embodiments, the motor 20 includes a length of between approximately 50 mm and approximately 70 mm (e.g., approximately 55 mm, approximately 65 mm, etc.). In one embodiment, the motor 20 includes a length of approximately 59 mm. In another embodiment, the motor 20 includes a length of approximately 55.5 mm. In other embodiments, the motor 20 includes a length of approximately 57.5 mm.

In some embodiments, the rotor 25 includes a diameter of between approximately 35 mm and approximately 45 mm (e.g., approximately 38 mm, approximately 42 mm, etc.). In the illustrated embodiment, the rotor 25 includes a diameter of approximately 40 mm. In some embodiments, the rotor 25 includes an inner diameter of between approximately 30 mm and approximately 40 mm (e.g., approximately 32 mm, approximately 37 mm, etc.). In the illustrated embodiment, the rotor 25 includes an inner diameter of approximately 35 mm. In some embodiments, the rotor 25 includes a weight of between approximately 100 grams (g) and approximately 150 g (e.g., approximately 110 g, approximately 130 g, etc.). In the illustrated embodiment, the rotor 25 includes a weight of approximately 123.1 g.

In some embodiments, the cutting head 26, 226 includes a diameter (e.g., diameter of the outer radial profile 108) of between approximately 55 mm and approximately 70 mm (e.g., approximately 60 mm, approximately 65 mm, etc.). In the illustrated embodiment, the cutting head 26, 226 includes a diameter of approximately 62 mm. In some embodiments, the cutting head 26, 226 includes an inner diameter of between approximately 35 mm and approximately 45 mm (e.g., approximately 38 mm, approximately 42 mm, etc.). In the illustrated embodiment, the cutting head 26, 226 includes an inner diameter of approximately 40 mm. In some embodiments, the cutting head 26, 226 includes a weight of between approximately 180 g and approximately 220 g (e.g., approximately 190 g, approximately 210 g, etc.). In the illustrated embodiment, the cutting head 26, 226 includes a weight of approximately 200 g.

In some embodiments, the rotor 25 includes a rotor inertia of between approximately 0.000030 kgm^2 and approximately 0.000060 kgm^2 (e.g., approximately 0.000040 kgm^2, approximately 0.000050 kgm^2, etc.). In the illustrated embodiment, the rotor 25 includes a rotor inertia of approximately 0.000043 kgm^2. In some embodiments, the cutting head 26, 226 includes an outer inertia of between approximately 0.000100 kgm^2 and approximately 0.000180 kgm^2 (e.g., approximately 0.000120 kgm^2, approximately 0.000150 kgm^2, etc.). In the illustrated embodiment, the cutting head 26, 226 includes an outer inertia of approximately 0.000136 kgm^2. In some embodiments, the rotor 25 and the cutting head 26, 226 include a total inertia of between approximately 0.000150 kgm^2 and approximately 0.000220 kgm^2 (e.g., approximately 0.000170 kgm^2, approximately 0.000200 kgm^2, etc.). In the illustrated embodiment, the rotor 25 and the cutting head 26, 226 include a total inertia of approximately 0.000180 kgm^2. In some embodiments, the motor 22 includes a rotational speed of between approximately 9,000 RPM and approximately 12,000 RPM (e.g., approximately 10,000 RPM, approximately 11,000 RPM, etc.). In the illustrated embodiment, the motor 22 includes a rotational speed of approximately 10,756 RPM.

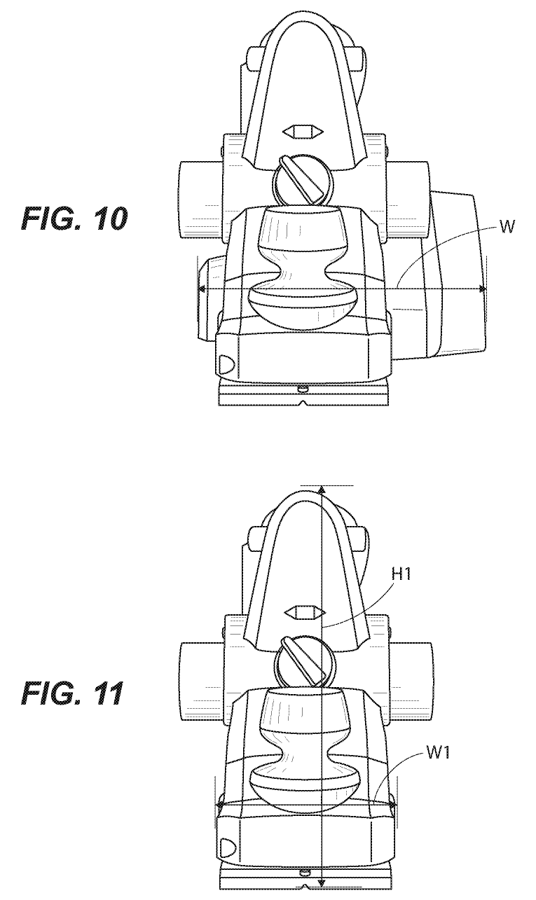

FIGS. 9 and 10 illustrate a height H and width W of a conventional belt-driven handheld planer. As illustrated in FIG. 11, by integrating the motor 22 and the cutter head 26 into a single mechanism (e.g., without the motor and cutter head being offset), in which the cutter head 26 surrounds and is directly driven by the motor 22, the planer 10 has smaller dimensions compared to other non-direct drive handheld planers. In some embodiments, the planer 10 includes a height H1 of between approximately 160 mm and approximately 110 mm (e.g., approximately 140 mm, approximately 120 mm, etc.). In the illustrated embodiment, the planer 10 includes a height H1 of approximately 140.97 mm. In other embodiments, the planer 10 includes a height H1 of approximately 122 mm. In some embodiments, the planer 10 includes a width W1 (e.g., overall width) of between approximately 85 mm and approximately 125 mm (e.g., approximately 105 mm, approximately 95 mm, etc.). In the illustrated embodiment, the planer 10 includes a width W1 of approximately 106.9 mm. In other embodiments, the planer 10 includes a width W1 of approximately 97 mm. Additionally, by integrating the blade retention mechanism 62, 162 within the outer radial profile 108 (FIG. 5) of the cutting head 26, 126, the overall size of the planer 10 is reduced compared to other conventional handheld planers.

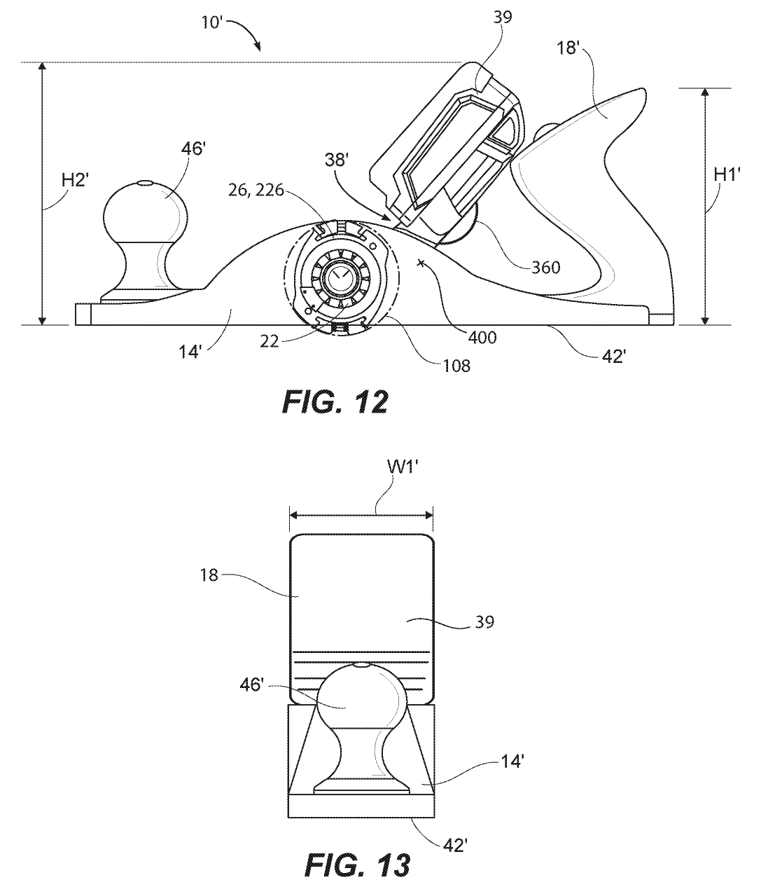

FIGS. 12 and 13 illustrate another embodiment of a planer 10’ for use with the cutting head 26, 226 and the battery pack 39, in which like components and features of the planer 10’ include an “‘” following the reference number.

As illustrated in FIGS. 11 and 12, the planer 10’ may include a main housing 14’ having handles 18’ extending upwardly from the main housing 14’ that are graspable by a user during use, the electric motor 22 supported within the main housing 14’ for rotatably driving the cutting head 26, 226 through an outer radial profile 108, and a battery receptacle 38’ for selectively electrically receiving the battery pack 39. The planer 10’ may also include a shoe 42’ and a knob 46’. In the illustrated embodiment, the knob 46’ may be adjustable and/or rigid. In some instances, the knob 46’ may be locked (e.g., rotationally constrained) and unlocked (e.g., rotatable) to allow a user to freely rotate the knob 46’ during use, thereby increasing usability of the planer 10’.

The planer 10’ may further include a cutting depth adjuster 360. In the illustrated embodiment, the depth adjuster 360 is positioned remote from the knob 46’ to reduce accidental depth adjustment during planing operations. Because the planer 10’ has a similar cutter-head-integrated motor arrangement to the planer 10, the planer 10’ may also have smaller dimensions compared to other non-direct drive handheld planers and/or to the planer 10.

In some embodiments, the planer 10’ includes a first height H1’, measured between the shoe 42’ and a tip of the handle 18’, of between approximately 89 mm and approximately 140 mm (e.g., approximately 110 mm, approximately 127 mm, etc.). In the illustrated embodiment, the planer 10’ includes a first height H1’ of approximately 114.3 mm (e.g., approximately 4.5 inches).

In some embodiments, the planer 10’ includes a second height H2’, measured between the shoe 42’ and a tip of the battery pack 39 coupled to the battery receptacle 38’, of between approximately 140 mm and approximately 165 mm (e.g., approximately 150 mm, approximately 155 mm, etc.). In the illustrated embodiment, the planer 10’ includes a second height H2’ of approximately 139.7 mm (e.g., approximately 5.5 inches).

In some embodiments, the planer 10’ includes a width W1’. In the illustrated embodiment, the width W1’ is measured between sides of the battery pack 39 and is between approximately 38.1 mm and approximately 115 mm (e.g., approximately 60 mm, approximately 90 mm, etc.). In the illustrated embodiment, the planer 10’ includes a width W1’ of approximately 88.9 mm (e.g., approximately 3.5 inches). In some instances, the width W1’ is measured between sides of the housing 14’. In such instances, the width W1’ may be approximately 63.5 mm (e.g., 2.5 inches).

The planer 10’ may have a center of gravity 400 (“CG”) and form factor similar to the CG and form factor of a traditional (e.g., non-powered) handheld planer. In one instance, the CG 400 is positioned centrally on the planer 10’ and adjacent and between the battery pack 39 and the cutting head 26, 226. In other instances, the CG may be higher or lower on the planer 10’.

Although the disclosure has described in detail certain preferred embodiments, variations and modifications exist within the scope and spirit of one or more independent aspects of the disclosure as described. For example, any component, feature, dimension, or the like described with respect to either the planer 10 or the planer 10’ could apply equally to both the planer 10 and the planer 10’.

Various features of the disclosure are set forth in the following claims.

What is claimed is:

1. A handheld workpiece finishing tool comprising:
a housing including a handle and a battery receptacle for selectively receiving a battery;
an electric motor supported by the housing, the electric motor including
a stator coupled to a stationary shaft, and
a rotor rotatable relative to the stator; and
a drum coupled to the housing and rotatably driven by the electric motor, the drum weighing less than 220 grams and including an outer radial profile having a diameter greater than 55 millimeters,
wherein the drum is coupled for co-rotation with the rotor about a rotational axis defined by the stationary shaft.

2. The handheld workpiece finishing tool of claim 1, wherein the diameter of the outer radial profile is less than 70 millimeters.

3. The handheld workpiece finishing tool of claim 1, wherein the rotor has a diameter greater than 45 millimeters.

4. The handheld workpiece finishing tool of claim 1, wherein the drum is a cutting head including a channel defined by opposing sidewalls formed on an outer radial surface of the cutting head, and a blade retention mechanism located within the channel for retaining a cutting blade.

5. The handheld workpiece finishing tool of claim 1, wherein the drum weighs more than 180 grams.

6. The handheld workpiece finishing tool of claim 1, wherein the rotor includes a rotor inertia greater than 0.000030 kgm^2, and wherein the drum includes an outer inertia greater than 0.000100 kgm^2.

7. The handheld workpiece finishing tool of claim 6, wherein the rotor and the drum include a total inertia of greater than 0.000150 kgm^2.

8. The handheld workpiece finishing tool of claim 7, wherein the electric motor includes a rotational speed greater than 9,000 rotations per minute.

9. A handheld planing tool comprising:
a main housing including a shoe, a handle, and a battery receptacle for selectively receiving a battery, the main housing defining a height between the shoe and the handle;
an electric motor supported by the main housing, the electric motor including a stator coupled to a stationary shaft, and a rotor positioned radially outward of the stator; and
a cutting head coupled to the main housing and rotatably driven by the electric motor, the cutting head including
a channel defined by opposing sidewalls formed on an outer radial surface of the cutting head, and
a blade retention mechanism located within the channel for retaining a cutting blade,
wherein the cutting head has a diameter greater than 55 millimeters, and
wherein the height is less than 140 millimeters.

10. The handheld planing tool of claim 9, further comprising an overall width, wherein the overall width is less than 115 millimeters.

11. The handheld planing tool of claim 10, wherein the blade retention mechanism includes a blade holder for clamping the cutting blade between one of the opposing sidewalls and the blade holder.

12. A handheld planing tool comprising:
a housing including a handle and a battery receptacle for selectively receiving a battery;
an electric motor supported by the housing; and
a cutting head coupled to the housing and rotatably driven by the electric motor, the cutting head including
a channel defined by opposing sidewalls formed on an outer radial surface of the cutting head, and
a blade retention mechanism located within the channel for retaining a cutting blade, the blade retention mechanism having a blade holder for clamping the cutting blade between one of the opposing sidewalls and the blade holder.

13. The handheld planing tool of claim 12, wherein the electric motor includes
a stationary shaft coupled to the housing and extending through the cutting head, the stationary shaft defining a rotational axis,
a stator fixed to the stationary shaft, and
a rotor located external to the stator, the rotor being configured to rotate around the stator about the rotational axis.

14. The handheld planing tool of claim 13, wherein the rotor is coupled for co-rotation with the cutting head, and wherein the cutting head and the rotor co-rotate about the rotational axis.

15. The handheld planing tool of claim 12, wherein the blade retention mechanism further includes a plurality of threaded rods, and wherein the blade holder includes a plurality of jaws each coupled on opposing sides of the plurality of threaded rods.

16. The handheld planing tool of claim 15, wherein the threaded rods are rotatable to move the jaws circumferentially along the outer radial surface of the cutting head in opposite directions to clamp the cutting blade between one of the opposing sidewalls and the blade holder.

17. The handheld planing tool of claim 13, further comprising a flange supporting the stationary shaft, wherein one or more conductors are routed from the housing to the electric motor through a passage formed in the flange.

18. The handheld planing tool of claim 12, further comprising:
a controller configured to detect a condition including a kick-back condition, a stall condition, a rapid deceleration condition, or an over-current condition,
wherein the controller is further configured to automatically stop the electric motor in response to the condition that is detected.

19. The handheld planing tool of claim 18, further comprising:
an adjustment knob configured to adjust a cutting depth; and
an inductive sensor configured to detect a position of the adjustment knob and/or a position of a front shoe that corresponds to the cutting depth.

20. The handheld planing tool of claim 19, wherein the controller is configured to inhibit operation of the electric motor unless both (i) a trigger is actuated and (ii) a second input is detected to require a two-handed operation.
